(19) United States
(12) Patent Application Publication
(10) Pub. No.: US 2013/0238977 A1
(43) Pub. Date: Sep. 12, 2013

(54) METHOD AND SYSTEM FOR MASTER-PAGE BASED INTEGRATED EDITING AND DYNAMIC LAYOUT ACTIVATION

(71) Applicant: WIXPRESS LTD, Tel Aviv (IL)

(72) Inventors: Nadav ABRAHAMI, Tel Aviv (IL); Giora KAPLAN, Tel Aviv (IL); Avishai ABRAHAMI, Tel Aviv (IL)

(73) Assignee: WIXPRESS LTD, Tel Aviv (IL)

(21) Appl. No.: 13/786,488

(22) Filed: Mar. 6, 2013

Related U.S. Application Data
(60) Provisional application No. 61/607,094, filed on Mar. 6, 2012.

(51) Int. Cl. G06F 17/22

(52) U.S. Cl. CPC G06F 17/2247
USPC 715/234

(57) ABSTRACT

A website editor implementable on a computing device, The editor includes an associator to associate at least one regular page to a master page, a displayer to display the elements of the least one regular page and the elements of the master with visual markings to visually distinguish between them and an editing component to allow concurrent editing of the elements of the at least one regular page and the master page.

### CROSS-REFERENCE TO RELATED APPLICATIONS

This application claims priority from U.S. Provisional Patent Application No. 61/607,094 filed Mar. 6, 2012 which is hereby incorporated in its entirety by reference.

### FIELD OF THE INVENTION

The present invention relates to the building of online visual design systems using master pages generally and to dynamic layout in particular.

### BACKGROUND OF THE INVENTION

Current visual design systems use a WYSIWYG (What You See Is What You Get) metaphor to provide a convenient, high-productivity and easy to use environment for the creation and editing of graphical applications and creations. Such creations or applications can include web sites, catalogs, presentations, e-shops, flow diagrams and as well as other application categories. These creations are deployed to systems which display them on a display screen, or to systems which print them.

Visual design systems may be standalone (such as the Microsoft Visio diagram editor or the Microsoft PowerPoint presentation program), or may be embedded inside a larger editing system (such as the Microsoft Word AutoShapes editor). A designer using such a system may design a new creation from scratch (starting with a blank screen), or may rely on predefined application templates created by the designer himself or herself, by the system creator, or by the designer community. When an application template is provided, the designer can customize it at will—adding, removing or modifying all elements of the template to create his or her own version of the template.

Applications usually consist of multiple pages. An application can include any number of pages which can be typically added and removed by the designer as required. Pages usually contain components which may be atomic (e.g. these which cannot be decomposed into sub-components), or container (which occupy a given screen area and can contain one or more other sub-components). Container components can be nested to a number of levels. Some containers (such as a general-purpose “area” container) can contain components of multiple types, and some containers are limited to contain specific types or classes of contained components (such as photo album container which may only contain picture components).

Components do not have to occupy mutually exclusive screen regions, and may in fact geometrically intersect each other. A component may also be situated completely within the boundaries of another component. The screen area overlap may be coupled with a logical containment (i.e. the component “belongs” to a given container—and moves with the container wherever it goes), or be a mere geometrical overlap which is not based on any containment relationship.

Whenever components intersect, a display priority attached to each component controls which component is displayed on top of which component. A visual design system typically employs a layout manager which manages component places, sizes, display order and related issues. Components may be fixed in shape and content, may be based on a content management system or may be based on user specified content such as a text area into which the designer enters text. Dynamic components can be based on external information (static or dynamic), such as a RSS feed displaying information from an external data source or the content of a given internet page.

Component appearance and screen area can be modified by resizing, moving, rotation and other operations, and also by choosing an alternative display version for the component or parts thereof (e.g. a blog component whose size can change when blog entries are expanded or shrunk).

Complex applications typically include numerous pages which share common components and other elements. As is known in the art, the design of such complex application may be performed though the use of templates or master pages, each of which is used as the basis for multiple similar regular application pages. This feature has many names in different systems, such as master, master page, template or master slide. It can be found in systems such PowerPoint or Visio commercially available from the Microsoft Corporation. These template pages may be known as master pages and the term regular pages to refer to the pages which not master pages themselves.

Some systems simply duplicate the master page into the newly created regular page at creation time, without establishing a persistent connection between the regular page and the master page. In these systems changes to the master page are not reflected in the regular pages created based on it. Other systems do establish such a persistent connection (which may be modified by the designer). In the later type of system, a master page may be modified and the changes are dynamically reflected in all pages which were created based on this master page (before or after the master page was modified). This persistent link is known as a page association, so that a given master page is associated with the regular pages which use it as a foundation, and these regular pages in turn are said to be associated with the master page used to create them.

Reference is now made to FIG. 1 which illustrates a master page MP1 which includes components [a1] and [a2] and is associated with the regular pages RP1, RP2 and RP3. All three regular pages display the master page components [a1] and [a2], as well as their own page-specific components [b], [c], [d] and [e].

Dynamic layout is known in the art. U.S. patent application Ser. No. 13/771,119 filed Feb. 20, 2013, incorporated herein by reference and assigned to the common assignee of the present invention, describes dynamic layout and dynamic layout rules in more detail. Dynamic layout is often needed in cases in which components have to be moved or resized, and it is thus difficult—or impossible—to maintain the preplanned, exact layout. It involves the automatic moving and resizing of components on the screen when components (the components or other components affecting the components) change due to change in the content, content formatting, and direct change to geometrical properties (size, position) by the designer, or for any other reason. All of the above mentioned changes can be affected by the designer during an editing session on a specific application; by the end users of the created application during application use (whenever allowed by the designer) and by other designers working concurrently on the same application in systems which support collaborative authoring. Dynamic layout can also be triggered on external content change and by commands embedded in the application itself etc.

### SUMMARY OF THE PRESENT INVENTION

There is provided, in accordance with a preferred embodiment of the present invention, a website editor implementable on a computing device. The editor includes an associator, a displayer and an editing component. The associator associates at least one regular page to a master page. The displayer displays elements of the least one regular page and elements of the master page with visual markings to visually distinguish between them and the editing component allows concurrent editing of the elements of the at least one regular page and the elements of the master page.

Moreover, in accordance with a preferred embodiment of the present invention, the master page also includes a page group component to retain the at least one regular page.

Further, in accordance with a preferred embodiment of the present invention, the editing component includes an editing mode switcher to switch editing modes between editing the master page and editing the at least one regular page.

Still further, in accordance with a preferred embodiment of the present invention, the editing mode switcher includes a marker to provide a visual marking to indicate which of the master page and the at least one regular page is currently editable.

Additionally, in accordance with a preferred embodiment of the present invention, the editing component includes a regular page switcher to switch the current regular page being displayed and edited.

Further, in accordance with a preferred embodiment of the present invention, regular page switcher includes a visual menu arrangement to activate the regular page switcher.

Still further, in accordance with a preferred embodiment of the present invention, the editor also includes a dynamic layout editor to update the elements of the master page and the elements of the at least one regular page according to the concurrent editing.

Moreover, in accordance with a preferred embodiment of the present invention, the displayer displays the dynamic layout updates.

Additionally, in accordance with a preferred embodiment of the present invention, the displayer displays the dynamic layout updates through an animation effect.

There is also provided, in accordance with a preferred embodiment of the present invention, a method for website editing. The method includes associating at least one regular page to a master page, displaying elements of the least one regular page and elements of the master with visual markings to visually distinguish between them and concurrent editing of the elements of the at least one regular page and the elements of the master page.

Further, in accordance with a preferred embodiment of the present invention, the concurrent editing includes switching editing modes between the master page and the at least one regular page.

Still further, in accordance with a preferred embodiment of the present invention, the switching includes providing a visual marking to indicate which of the master page and the at least one regular page is currently editable.

Additionally, in accordance with a preferred embodiment of the present invention, the concurrent editing includes switching the current regular page being displayed and edited.

Moreover, in accordance with a preferred embodiment of the present invention, the method also includes activating the switching the current regular page.

Further, in accordance with a preferred embodiment of the present invention, the concurrent editing includes moving the elements of the at least one regular page and the elements of the master page between the master page and the at least one regular page.

Still further, in accordance with a preferred embodiment of the present invention, the moving preserves the attributes of the elements of the at least one regular page and the elements of the master page.

Additionally, in accordance with a preferred embodiment of the present invention, the method also includes dynamic layout editing and wherein the dynamic layout editing includes updating the elements of the at least one regular page and the elements of the master page according to the concurrent editing.

Finally, in accordance with a preferred embodiment of the present invention, the updating also includes presenting the updated elements through an animation effect.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of the association between master pages and regular pages;

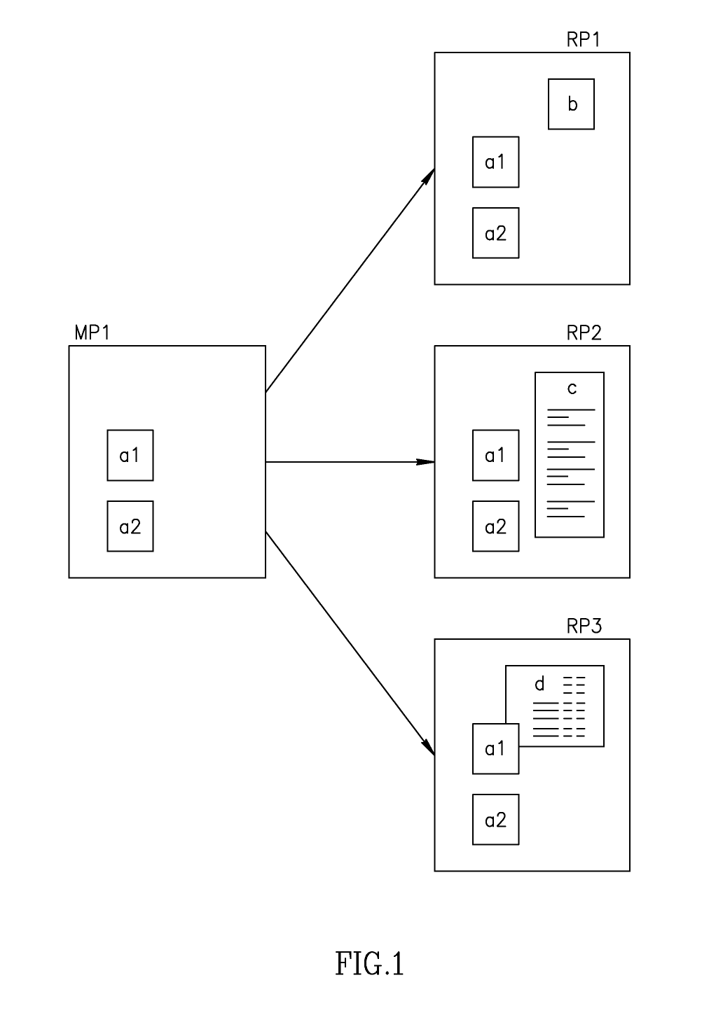

FIG. 2 is a schematic illustration of the use of associated pages and standalone pages;

FIGS. 3A and 3B are schematic illustrations of composite pages, constructed and operative in accordance with the present invention;

FIG. 4 is a schematic illustration of the bipartite nature of the page associations, constructed and operative in accordance with the present invention;

FIG. 5 is a schematic illustration of a website editor for the association of master pages and regular pages and their display, constructed and operative in accordance with the present invention;

FIG. 6 is a schematic illustration of dynamic layout use in conjunction with multiple regular pages in the same page group component, constructed and operative in accordance with the present invention;

FIG. 7 is a schematic illustration of the use editor of FIG. 5 in conjunction with a dynamic layout editor.

FIG. 8 is a schematic illustration of the shading of master page components in regular page editing mode, constructed and operative in accordance with the present invention;

FIG. 9 is a schematic illustration of the flow of editing sessions when editing multiple regular pages, constructed and operative in accordance with the present invention;

FIGS. 10A and 10B are schematic illustrations of the visual regular page menu design; constructed and operative in accordance with the present invention; and

FIG. 11 is a schematic illustration of the implementation of the combined editors of FIG. 7 on a remote server, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

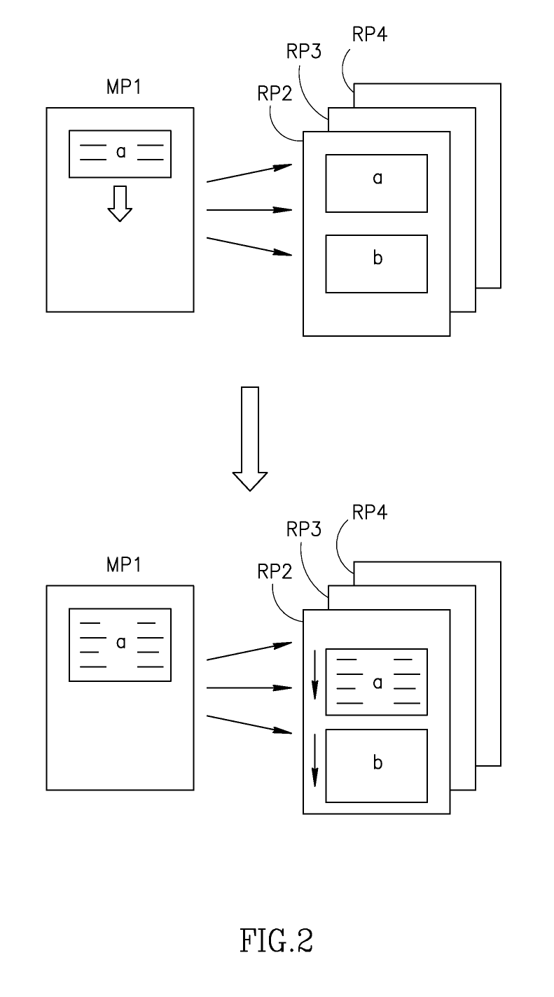

Applicants have realized that for existing visual design systems, it is often difficult for a designer to visualize the effects that changes to a master page may have on the various regular pages associated with it. This often requires numerous page switching operations in the design environment, or the opening of numerous windows. Reference is now made to FIG. 2 which illustrates a typical page setup in which the various components of the various pages are arranged so that the components residing in the master page (and thus displayed on all associated regular pages) form a common top, bottom or side menu, whereas the specific regular page components are located in the middle section. As is shown, component [a] is located towards the top of the page on MP1 as well as on all associated regular pages RP2, RP3 and RP4. Component [b], specific to page RP2 only is located in the middle of page RP2 only. Therefore if component [a] is, for example, moved downwards, it may be desirable to move component [b] downwards as well. In this scenario, the designer would not only have to work with page P1, he would also have to work with page P2 separately.

Applicants have further realized that a system that allows the simultaneous editing of master pages and their associated regular pages may also be integrated with dynamic layout principles to improve the flexibility of design and allow changes in regular pages to affect the way the master page components are displayed and vice versa.

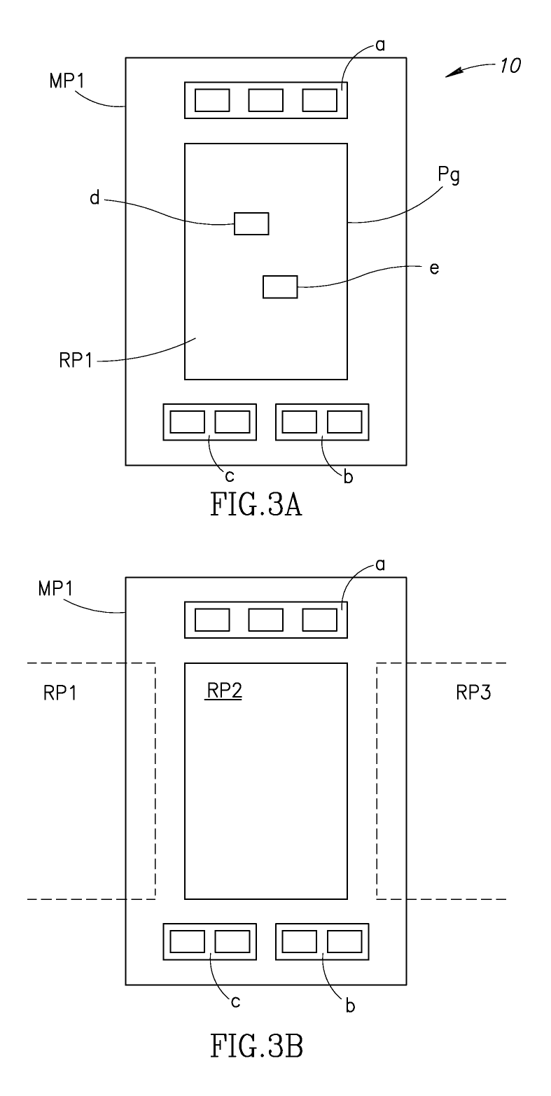

Reference is now made to FIGS. 3A and 3B which illustrate a composite page 10 in accordance with an embodiment of the present invention. Composite page 10 may comprise a master page MP1 and one or more regular pages RP2. Master page MP1 may further comprise of master page components [a], [b] and [c] and a page group component [pg]. Regular page RP1 may comprise regular page components [d] and [e]. It will further be appreciated that page group component [pg] may be likened to a form of place holder, holding a single associated regular page at any one time during run time, but with the ability to change the current regular page as is illustrated in FIG. 3B (described in more detail herein below). Master page MP1 may have three regular pages associated with it—RP1, RP2 and RP3. It will be appreciated that master page MP1 components [a], [b] and [c] may be displayed on all the corresponding regular pages RP1, RP2 and RP3. It will be further appreciated that in general, all master page components may be positioned above page group component [pg] (such as component [a]), below page group component [pg] (such as components [b] and [c]), to the side of page group component [pg] or overlapping page group component [pg]. A master page component that overlaps page group component [pg] is not logically contained in page group component [pg], but is merely considered to geometrically overlap page group component [pg]. Since the master page components [a], [b] and [c] are common to pages RP1, RP2 and RP3, it will be appreciated that during editing mode, a designer may be able to toggle between the three different regular pages, each time viewing the page together with MP1 for easy simultaneous editing of the pages as described in more detail herein below.

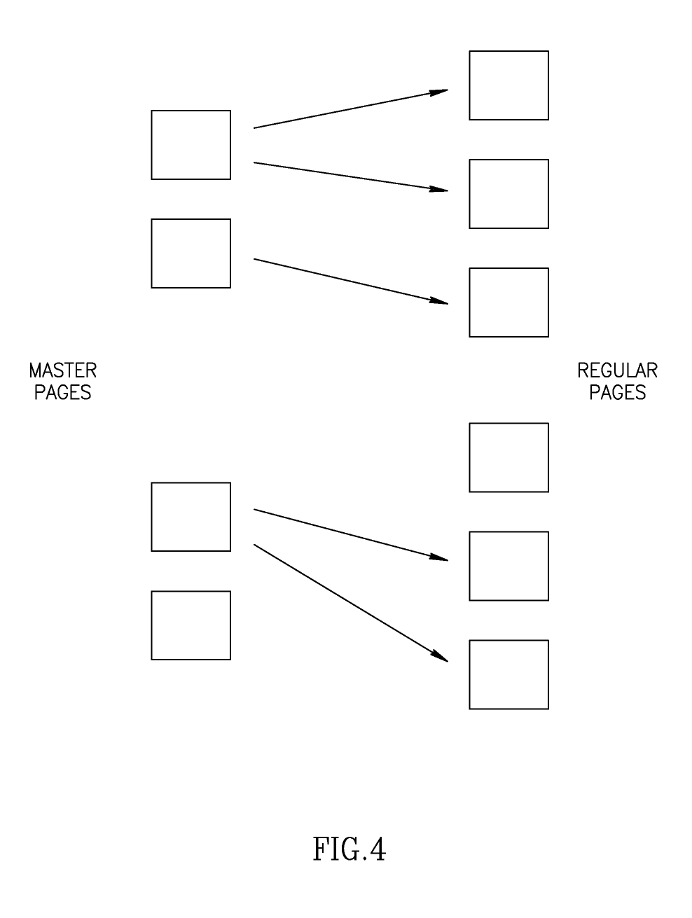

It will be appreciated that a regular page may be associated with a master page or with no master page at all (known as a standalone regular page). It will also be appreciated that a single master page may be associated with multiple regular pages or with no regular pages at all (known as a standalone master page). This association may be represented by a bipartite graph as is illustrated in FIG. 4 to which reference is now made. Master pages may not be associated with other master pages and regular pages may not be associated with other regular pages.

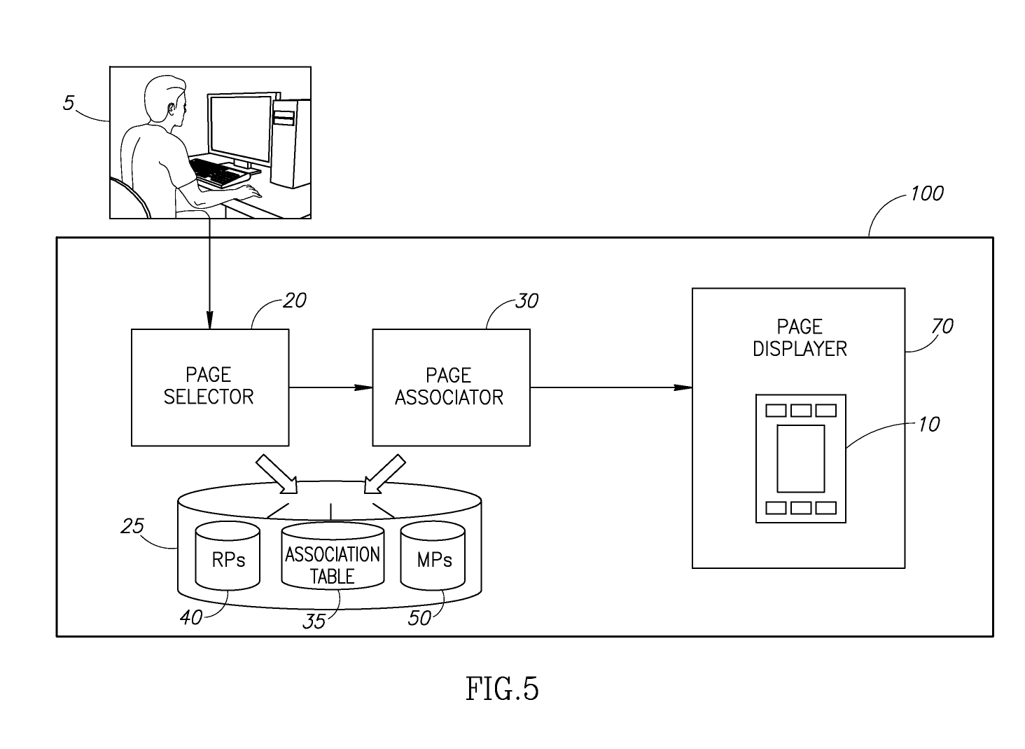

It will be appreciated that all associations between master pages and regular pages may be created, modified and removed by a designer. Reference is now made to FIG. 5 which illustrates a website editor 100 for the association of master pages and regular pages and their display, in accordance with an embodiment of the present invention. Editor 100 comprises a page selector 20, a page associator 30, a database 25 and composite page displayer 70. Database 25 comprises a regular page sub-database 40, a master page sub-data base 50 and an association table 35. Designer 5, through a suitable user interface in conjunction with editor 100, may use page selector 20 to select a single master page from master page sub-database 50 and any number of regular pages from regular page sub-database 40. Once the selection has been made, page associator 30 may associate and combine the chosen pages to create composite page 10 saving the pertinent associations in association table 35. It will be appreciated that page associator 30 may geometrically map the regular page components from the page area assigned to the regular page to the group page component. This mapping may be done according to page width and since the various regular pages may have different heights (due to components extending downwards, different page y-values etc.) the page group component is appropriately re-sized. Dynamic layout may also be triggered at this stage (as described in more detail herein below). Displayer 70 may then display composite page 10 accordingly (i.e. a master page with an associated regular page). Page displayer 70 may also display the combined components of composite page 10 according to the pertinent editing mode as is described in more detail herein below.

It will be appreciated that when displayer 70 loads a particular master page for the first time, displayer 70 may look up the associated regular pages for the pertinent master page from association table 35 and may display the first (page-order wise) regular page. If displayer 70 loads the master page after stepping through its various regular pages, the current regular page is loaded. It will also be appreciated, that if displayer 70 loads a regular page, displayer 70 may automatically load the associated master page.

It will be appreciated that editor 100 may be a software component running on a local computing device. The software may be a pre-installed application, a dynamically downloaded application (such as a Flash application) or a browser based application (which may run inside the browser using technologies such as HTML5 and JavaScript. Editor 100 may also be installed on a remote server (as described in more detail herein below). It will be further appreciated that hardware may range from a personal or tablet computer to a mobile communication device.

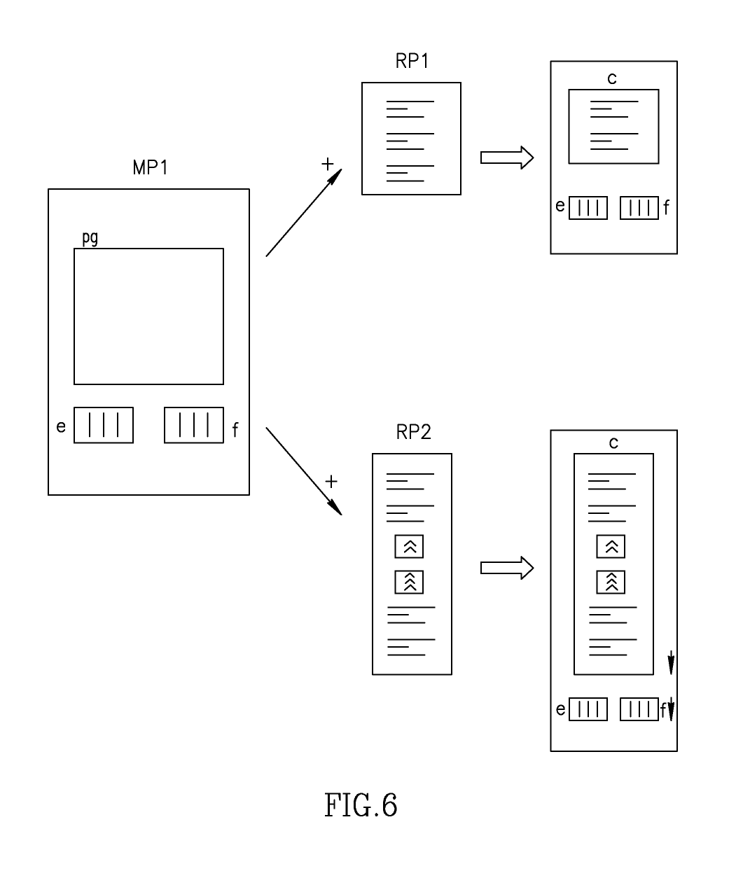

As discussed herein above, dynamic layout principles may be applied to editor 100 to move and resize components when needed as a result of the master page/regular page association. This is typically required when the same master page is associated with multiple regular pages, since different multiple regular pages (which may all reside in the same page group component) may have different sizes and therefore occupy different amounts of space. Therefore the pertinent page group component may need to be resized/moved each time to accommodate the pertinent regular page in use. This resizing may require the resizing/movement of the master page components as is illustrated in FIG. 6 to which reference is now made. Master page MP1 may comprise of page group component [pg] and components [e] and [f]. When master page MP1 is used in conjunction with regular page RP1, page group component [pg] is displayed using its original size. When master page MP1 is used in conjunction with regular page RP2 (which extends further than RP1), page group component [pg] is automatically extended downwards as are components [e] and [f] if an appropriate dynamic layout association has been defined between the pertinent components.

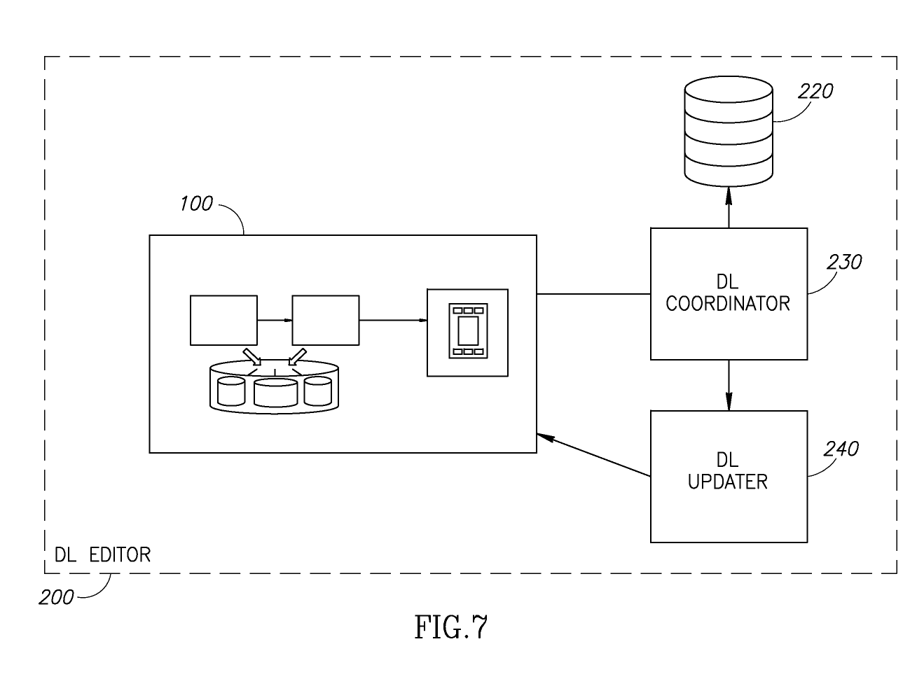

Reference is now made to FIG. 7, which illustrates the implementation of editor 100 in conjunction with a dynamic layout editor 200. Dynamic layout editor 200 may comprise a dynamic layout database 220, a dynamic layout coordinator 230 and a dynamic layout updater 240. It will be appreciated that these elements are functionally similar to those described in U.S. patent application Ser. No. 13/771,119.

It will be appreciated that page displayer 70 may display composite page 10 via different modes—end-user mode, master page editing mode and regular page editing mode. It will further be appreciated that the general view of composite page 10 is the master page together with a pertinent regular page. It will be appreciated that for all three types of modes, the master page is presented with the pertinent regular page displayed in the page group component. The components from both the master page and the regular page are all displayed based on their regular z-order and overlap handling conventions used by the pertinent website.

It will also be appreciated that an end-user may view a standalone regular page which will be shown as it was defined and may be mapped to the viewing screen according to its own page boundaries. An end user may not view a master page by itself, only by viewing a regular page associated with it as is described herein above. Thus, a standalone master page is only useful as a placeholder for the designer (e.g. to be used for associating future regular pages), since the end-user cannot access them. It will also be appreciated that in end-user mode, the end-user is not made aware of the differences between master page and regular page components. Thus, all special manipulation handles, tooltips and other user interface elements (discussed in more details herein below) do not appear in this mode.

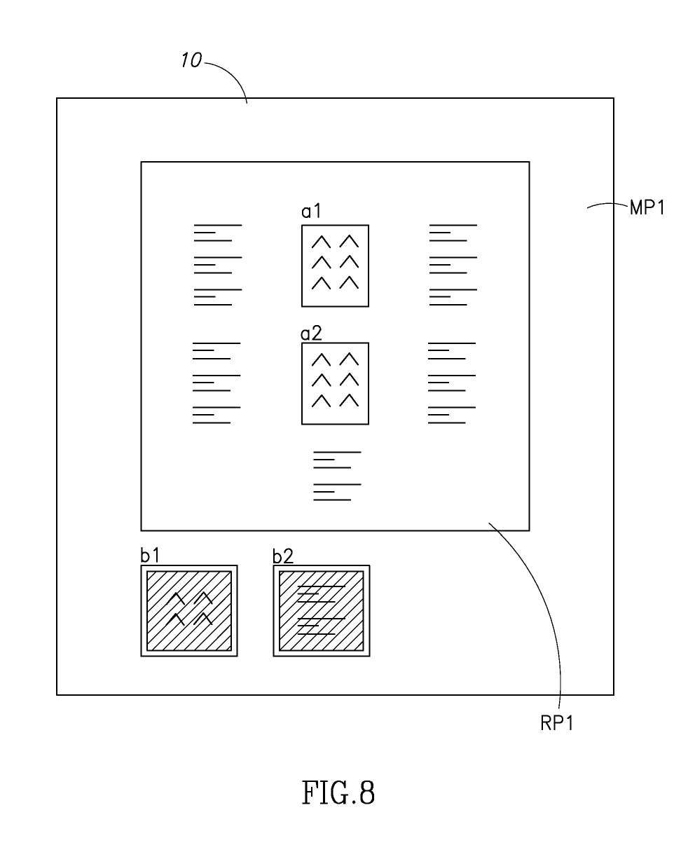

As discussed herein above, another display mode is regular page editing mode. This is the mode used to edit the entire composite page 10 (comprising a master page and a regular page), while focusing on the details and the components of the specific regular page. In this mode, page displayer 70 may display the pertinent composite page 10, thus displaying all the combined components. The regular page components may be displayed normally while the master page components are displayed with some form of visual marking to distinguish them. This visual marking may be a specific color, an added visual marking such as an extra frame, an alteration to the display style of the component such as a specific type of frame style, an animation or any of the above attributes which may be activated during editing when the designer's mouse approaches the component. Reference is now made to FIG. 8 which illustrates a composite page 10 comprising of master page MP1 and regular page RP1. Components [a1] and [a2] belonging to regular page RP1 are displayed normally, whereas components [b1] and [b2] belonging to master page MP1 are shaded to distinguish between them.

It will be appreciated that this display of visual marking may be defined by designer 5 or may be assigned by page displayer 70 (page displayer 70 recognizing which components belong to master page MP1 and which components belong regular page RP1). It will be further appreciated that the selection of type and intensity of visual marking may be automatically assigned to provide the biggest contrast between the two sets of components. It will be appreciated that the parameters for the assigned visual marking may be saved together with the pertinent pages in the pertinent database. Thus designer 5 may easily distinguish between the different sets of components while editing a large set of regular pages.

It will also be appreciated that master page editing mode may be used to edit composite page 10, while focusing on the details and the components of the specific master page. In this mode, the master page components are shown normally and the regular page components are displayed with some form of visual marking as is described hereinabove. It will be appreciated that the master page may be standalone or may be associated with one or more regular pages. For the latter case, the first regular page may be displayed automatically within the page component when the master page is initially edited.

It will be appreciated that for both editing modes, dynamic layout processing may also occur in order to preserve the page arrangement and relationship between the regular page components and the master page components.

It will be further appreciated that page displayer 70 may define additional modes of display such as a thumbnail mode in which multiple regular pages RP1 are visible at any one time. Displayer 70 may also extend or limit access to these modes such as allowing end-users a limited use of the regular page editing mode (to modify the application they are using), or allowing only specific (senior) designers to use the master page editing mode while limiting most designers to edit only the regular pages and their components.

It will also be appreciated that a designer may switch between master page editing mode and regular page editing mode without having to exit or switch editing session. In this manner, while editing composite page 10, designer 5 may edit either the regular page itself or the associated underlying master page, while continuing to view the same components. It will be appreciated that the mode switch may be affected though a user interface element which may toggle between the modes. Alternatively, the modes may be switched when a mouse gesture is performed on a component or area which “belongs to the opposite” mode. For example, when the designer is using master page editing mode, he may click on the page component or any of the regular page components and switch to regular page editing mode. It will be appreciated, that when switching between the two modes, the display remains the same except for the use of the visual markings to differentiate between the two sets of components.

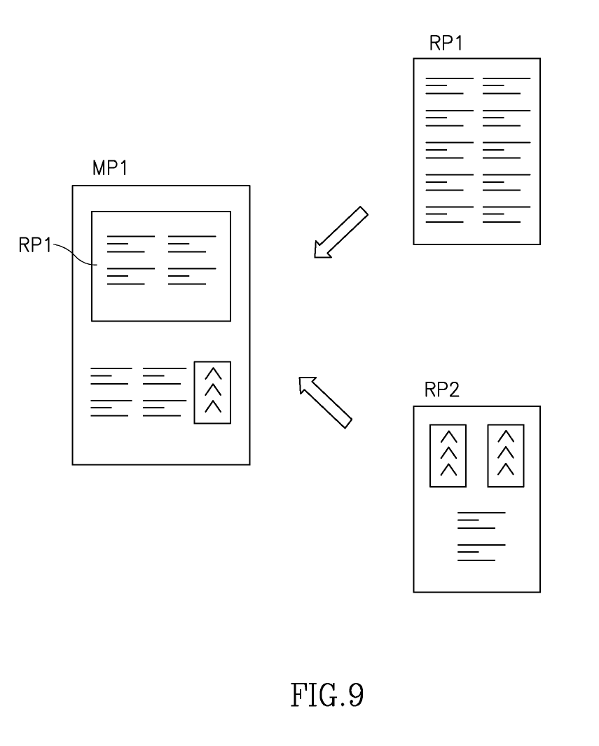

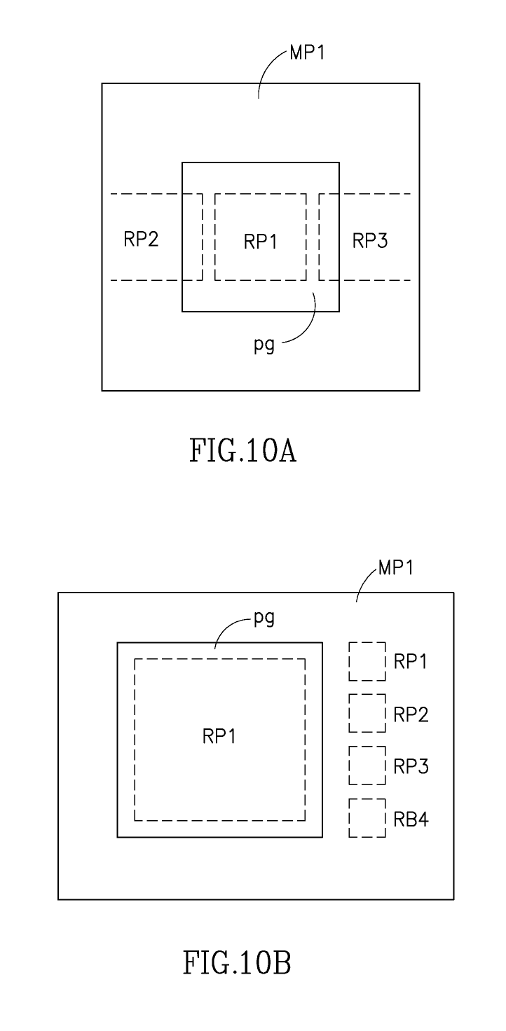

As described herein above, designer 5 may typically view a composite page 10 consisting of a master page with an associated regular page displayed within the page group component (in both master page editing mode or regular page editing mode). Reference is now made to FIG. 9 which illustrates two regular pages RP1 and RP2 both associated with master page RP1. Designer 5 working with master page MP1 together with regular page RP1 may wish to continue edit master page MP1 in conjunction with regular page RP2 instead. To facilitate this, page displayer 70 may allow switching or flipping between the two regular pages RP1 and RP2. It will be appreciated that regular pages may be typically ordered according to their order as pages in the application. The switching may be done instantly (i.e. the new regular page replaces the existing page instantly) or by using some form of transition effect (such as slide aside or dissolve) as is illustrated in FIG. 10A to which reference is now made. Regular pages RP1, RP2 and RP3 may interchanged by “sliding” them through the page component [pg]. It will also be appreciated that page displayer 70 may also display a visual menu showing ghost and or/thumbnail images of the pertinent regular pages so that the designer may pick a pertinent regular page RP1 for display with its master page MP1 as is illustrated in FIG. 10B to which reference is now made.

As discussed herein above, switching between different regular pages may trigger a dynamic layout mechanism to move and resize the page group container as well as other master page components in order to maintain the existing page structure. Furthermore, if the switching is performed using a transition that may take time, page displayer 70 may display the component changes caused by the dynamic layout process using animation (i.e. the pertinent components move gradually).

It will also be appreciated that it is often desirable to make an existing master page component into a regular page component for a specific regular page (so it would be shown only on the pertinent regular page), without affecting the properties of the component or vice versa—making an existing regular page component into a master page component. It will be further appreciated that executing such a change may not affect the current display of components, since the component is visible to the designer, whether it belongs to the master page or the regular page. However, if designer 5 switches regular pages, the component continues to be displayed if it is a master page component, but may no longer be visible if it is a regular page component. It will be appreciated that one possible method of “moving the component” may be through the use of a tooltip. Clicking on a tooltip may switch editing mode or may move the component to the opposite—type page. Another method may be through editing the property sheet of the pertinent component which is typically displayed when editing a component. The property sheet should clearly indicate if the component is associated with a master page or with a regular page. Yet another method may be by clicking on a specific area or element within the component itself (i.e. use a special handle). The area or handle may change shape when the component changes from a master page component to a regular page component and vice versa. Another method may be by physically dragging the component from outside the page group container into it and vice versa. It will be appreciated that this may not work for master page components which are placed in the same areas as the page group container or when component (master page or regular page) overlaps the page group container.

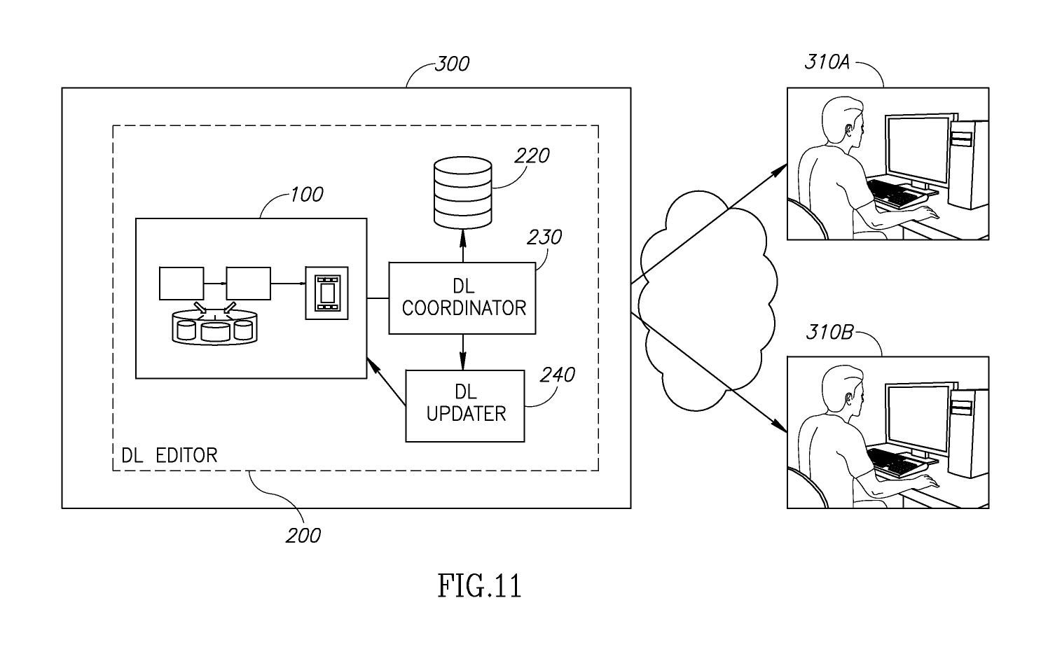

As discussed hereinabove, in an alternative embodiment to the present invention, both editors 100 and 200 may be implemented locally or on a remote server (either together or editor 100 as standalone) accessed by a communication medium such as the Internet, as is illustrated in FIG. 11 to which reference is now made. Editors 100 and 200 may reside on a remote server 300 which may be accessed by clients 310A and 310B. It will be further appreciated that this implementation may allow multiple designers and or users to create and use composite pages which may be shared with or without dynamic layout capabilities. In another embodiment, editors 100 and 200 may be integrated with a larger software system (such as the Facebook system) so as to provide a rich media application for editing, layout and display services inside the larger software system. Editors 100 and 200 may provide the user interface, or may function as a back-end engine, with a different front end system providing the actual user interface.

Therefore, whether designer 5 is in master page editing mode or in regular page editing mode, he may perform a number of actions to streamline his editing capabilities. He may switch between different regular pages while viewing the same master page, he may switch between different editing modes and he may change and/or move components from master page to regular page and vice versa. It will be appreciated that all these capabilities may be implemented based on user interface action and/or mouse gestures. It will be further appreciated that all of the above mentioned capabilities may be also be enhanced through the use of dynamic layout relationships and rules.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.)

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A website editor implementable on a computing device, the editor comprising:
an associator to associate at least one regular page to a master page;
a displayer to display elements of said least one regular page and elements of said master page with visual markings to visually distinguish between them; and
an editing component to allow concurrent editing of said elements of said at least one regular page and said elements of said master page.

2. The website editor of claim 1 and wherein said master page also comprises a page group component to retain said at least one regular page.

3. The website editor according to claim 1 and wherein said editing component comprises an editing mode switcher to switch editing modes between editing said master page and editing said at least one regular page.

4. The website editor according to claim 3 and wherein said editing mode switcher comprises a marker to provide a visual marking to indicate which of said master page and said at least one regular page is currently editable.

5. The website editor according to claim 1 and wherein said editing component comprises a regular page switcher to switch the current regular page being displayed and edited.

6. The website editor according to claim 5 and wherein said regular page switcher comprises a visual menu arrangement to activate said regular page switcher.

7. The website editor according to claim 1 and also comprising a dynamic layout editor to update said elements of said master page and said elements of said at least one regular page according to said concurrent editing.

8. The website editor according to claim 7 and wherein said displayer displays said dynamic layout updates.

9. The website editor according to claim 8 and wherein said displayer displays said dynamic layout updates through an animation effect.

10. A method for website editing, the method comprising:
associating at least one regular page to a master page;
displaying elements of said least one regular page and elements of said master with visual markings to visually distinguish between them; and
concurrent editing of said elements of said at least one regular page and said elements of said master page.

11. The method according to claim 10 and wherein said concurrent editing comprises switching editing modes between said master page and said at least one regular page.

12. The method according to claim 11 and wherein said switching comprises providing a visual marking to indicate which of said master page and said at least one regular page is currently editable.

13. The method according to claim 10 and wherein said concurrent editing comprises switching the current regular page being displayed and edited.

14. The method according to claim 13 and also comprising activating said switching the current regular page.

15. The method according to claim 10 and wherein said concurrent editing comprises moving said elements of said at least one regular page and said elements of said master page between said master page and said at least one regular page.

16. The method according to claim 15 and wherein said moving preserves the attributes of said elements of said at least one regular page and said elements of said master page.

17. The method according to claim 10 and also comprising dynamic layout editing and wherein said dynamic layout editing comprises updating said elements of said at least one regular page and said elements of said master page according to said concurrent editing.

18. The method according to claim 17 and wherein said updating also comprises presenting said updated elements through an animation effect.
